(19) United States
(12) Patent Application Publication
(10) Pub. No.: US 2018/0181762 A1
(43) Pub. Date: Jun. 28, 2018

(54) TECHNIQUES FOR PERSISTENT FIRMWARE TRANSFER MONITORING

(71) Applicant: INTEL CORPORATION, SANTA CLARA, CA (US)

(72) Inventors: RAJESH POORNACHANDRAN, PORTLAND, OR (US); NED M. SMITH, Beaverton, OR (US); VINCENT J. ZIMMER, Federal Way, WA (US); ATUL A. KHARE, Portland, OR (US); KARUNAKARA KOTARY, Portland, OR (US)

(73) Assignee: INTEL CORPORATION, SANTA CLARA, CA (US)

(21) Appl. No.: 15/393,198

(22) Filed: Dec. 28, 2016

(51) Int. Cl. G06F 21/57; G06F 21/55

(52) U.S. Cl. CPC G06F 21/577; G06F 2221/033; G06F 21/575; G06F 21/554

(57) ABSTRACT

Techniques and computing devices for persistent firmware transfer monitoring and, more specifically, but not exclusively, to a resource filter within a firmware resource monitor configured to persistently store resource information after a boot operation. In one embodiment, for example, an apparatus for persistent firmware transfer monitoring in a computer system comprises at least one memory, at least one processor, and a resource filter comprising logic, at least a portion of the logic comprised in hardware and executed by the processor. The logic to may be configured to receive a list of required resources during a boot operation and receive a list of excluded resources. The resource filter may be further configured to persistently store the list of required resources and the list of excluded resources after the boot operation has completed. It may be determined that one or more changes occurred to either of the list of required resources and the list of excluded resources during the boot process, and a security alert may be generated indicating a potential security threat. Other embodiments are described and claimed.

### TECHNICAL FIELD

Embodiments described herein generally relate to techniques for persistent firmware transfer monitoring and, more specifically, but not exclusively, to techniques for detecting vulnerabilities in system management mode.

### BACKGROUND

System management mode (SMM) is a special-purpose operating mode of a microprocessor. It is generally used for handling system-wide functions, such as processor power management, platform hardware configuration, and proprietary features. The SMM environment is initialized by the BIOS prior to booting the operating system and is entered at runtime when a System Management Interrupt (SMI) is asserted. The SMI itself is neither visible to, nor maskable by the operating system. The SMI uses SMM specific CPU mechanisms to transfer control to the BIOS SMI handler. The SMI is often thought of as “transparent” to the operating system, and data related to SMM is not typically available outside of the mode.

SMM is a potentially vulnerable state within a system because access to a CPU and other system resources is virtually unmitigated during SMM mode. Intruders within SMM mode may be able to cause significant damage to a computer system by manipulating a system during SMM mode. Further, since some actions taken during SMM mode are not persistent, i.e., are not stored past a boot-up phase, evidence of security breaches may not be easily detected. Thus, improved techniques to identify and prevent malicious activity during SMM are desirable.

### BRIEF DESCRIPTION OF THE DRAWINGS

FIG. 1 illustrates an embodiment of an operating environment.

FIG. 2 illustrates an embodiment of a system architecture.

FIG. 3 illustrates an embodiment of a system architecture.

FIG. 4 depicts an illustrative logic flow according to an embodiment.

FIG. 5 depicts an illustrative logic flow according to an embodiment.

FIG. 6 depicts an illustrative message flow according to an embodiment.

FIG. 7 illustrates an example of a centralized system.

FIG. 8 illustrates an example of a distributed system.

FIG. 9 illustrates an example of a storage medium.

FIG. 10 illustrates an example computing platform.

### DETAILED DESCRIPTION

Various embodiments may generally be directed toward persistent firmware transfer monitoring and, more specifically, but not exclusively, to a resource filter within a firmware resource monitor configured to persistently store resource information after a boot operation. In one embodiment, for example, an apparatus for persistent firmware transfer monitoring in a computer system comprises at least one memory, at least one processor, and a resource filter comprising logic, at least a portion of the logic comprised in hardware and executed by the processor. The logic may be configured to receive a list of required resources during a boot operation and receive a list of excluded resources. In an embodiment, the list of required resources may be received from a system BIOS and the list of excluded resources may be received from a virtual machine manager (VMM). Each list may include one or more of I/O components, memory-mapped I/O (MMIO) components, one or more memory ranges, and/or one or more system components. The resource filter may be further configured to persistently store the list of required resources and the list of excluded resources after the boot operation has completed. It may be determined that one or more changes occurred to either of the list of required resources and the list of excluded resources during the boot process, and a security alert may be generated indicating a potential security threat. Other embodiments are described and claimed.

In some embodiments, the determination that one or more changes have occurred may include, for each of a plurality of interface modules, determining whether a list of required resources and a list of excluded resources has changed during the boot process. The plurality of interface modules may include a trusted computing platform module (TPM), an active management technology module (AMT), and a firmware resource monitor module (FRM). The logic may be further configured to provide the results of the determination to a remote security console to perform a security ranking using gradient boosting machine learning and General Byzantine logic.

In the following description, numerous specific details such as processor and system configurations are set forth in order to provide a more thorough understanding of the described embodiments. However, the described embodiments may be practiced without such specific details. Additionally, some well-known structures, circuits, and the like have not been shown in detail, to avoid unnecessarily obscuring the described embodiments.

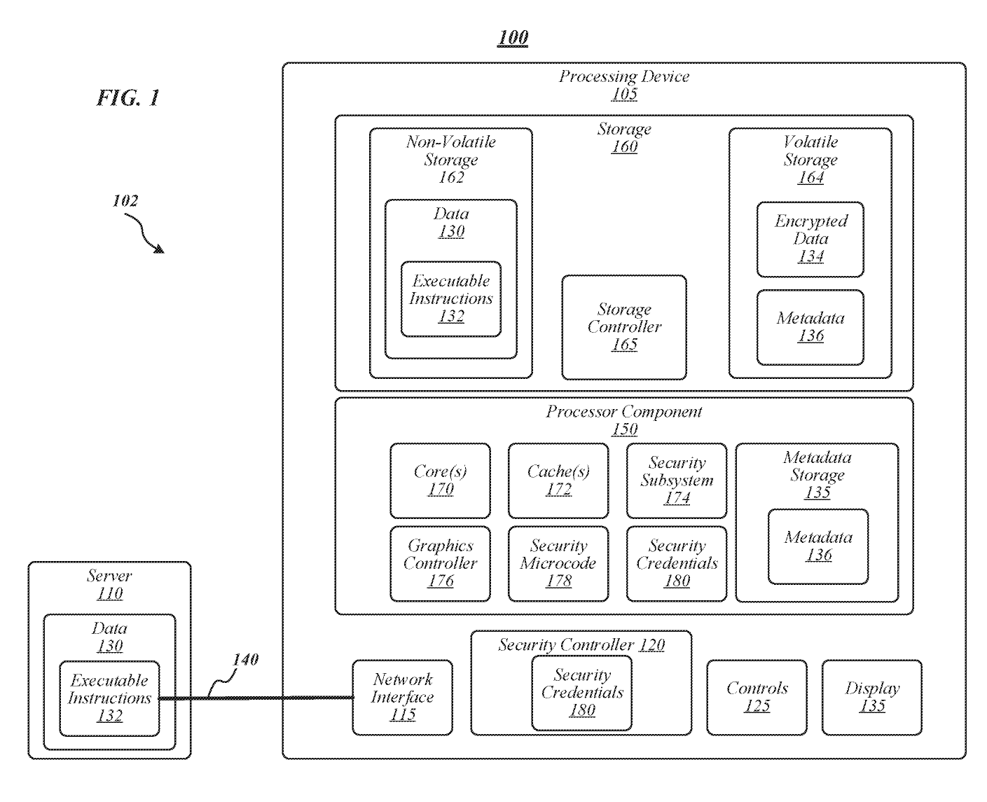

FIG. 1 illustrates an example of an operating environment 100 such as may be representative of some embodiments. In operating environment 100, which may include persistent firmware transfer monitoring, a system 102 may include a server 110 and a processing device 105 coupled via a network 140. Server 110 and processing device 105 may exchange data 130 via network 140, and data 130 may include executable instructions 132 for execution within processing device 105. In some embodiments, data 130 may be include data values, executable instructions, and/or a combination thereof. Network 140 may be based on any of a variety (or combination) of communications technologies by which signals may be exchanged, including without limitation, wired technologies employing electrically and/or optically conductive cabling, and wireless technologies employing infrared, radio frequency, and/or other forms of wireless transmission.

In various embodiments, processing device 105 may incorporate a processor component 150, a storage 160, controls 125 (for instance, manually-operable controls), a display 135 and/or a network interface 115 to couple processing device 105 to network 140. Processor component 150 may incorporate security credentials 180, a security microcode 178, metadata storage 135 storing metadata 136, a security subsystem 174, one or more processor cores 170, one or more caches 172 and/or a graphics controller 176. Storage 160 may include volatile storage 164, non-volatile storage 162, and/or one or more storage controllers 165. Processing device 105 may include a controller 120 (for example, a security controller) that may include security credentials 180. Controller 120 may also include one or more of the embodiments described herein for unified hardware acceleration of hash functions.

Volatile storage 164 may include one or more storage devices that are volatile in as much as they require the continuous provision of electric power to retain information stored therein. Operation of the storage device(s) of volatile storage 164 may be controlled by storage controller 165, which may receive commands from processor component 150 and/or other components of processing device 105 to store and/or retrieve information therein, and may convert those commands between the bus protocols and/or timings by which they are received and other bus protocols and/or timings by which the storage device(s) of volatile storage 164 are coupled to the storage controller 165. By way of example, the one or more storage devices of volatile storage 164 may be made up of dynamic random access memory (DRAM) devices coupled to storage controller 165 via an interface, for instance, in which row and column addresses, along with byte enable signals, are employed to select storage locations, while the commands received by storage controller 165 may be conveyed thereto along one or more pairs of digital serial transmission lines.

Non-volatile storage 162 may be made up of one or more storage devices that are non-volatile inasmuch as they are able to retain information stored therein without the continuous provision of electric power. Operation of storage device(s) of non-volatile storage 162 may be controlled by storage controller 165 (for example, a different storage controller than used to operate volatile storage 164), which may receive commands from processor component 150 and/or other components of processing device 105 to store and/or retrieve information therein, and may convert those commands between the bus protocols and/or timings by which they are received and other bus protocols and/or timings by which the storage device(s) of non-volatile storage 162 are coupled to storage controller 165. By way of example, one or more storage devices of non-volatile storage 162 may be made up of ferromagnetic disk-based drives (hard drives) operably coupled to storage controller 165 via a digital serial interface, for instance, in which portions of the storage space within each such storage device are addressed by reference to tracks and sectors. In contrast, commands received by storage controller 165 may be conveyed thereto along one or more pairs of digital serial transmission lines conveying read and write commands in which those same portions of the storage space within each such storage device are addressed in an entirely different manner.

Processor component 150 may include at least one processor core 170 to execute instructions of an executable routine in at least one thread of execution. However, processor component 150 may incorporate more than one of processor cores 170 and/or may employ other processing architecture techniques to support multiple threads of execution by which the instructions of more than one executable routine may be executed in parallel. Cache(s) 172 may include a multilayer set of caches that may include separate first level (L1) caches for each processor core 170 and/or a larger second level (L2) cache for multiple ones of processor cores 170.

In some embodiments in which processing device 105 includes display 135 and/or graphics controller 176, one or more cores 170 may, as a result of executing the executable instructions of one or more routines, operate controls 125 and/or the display 135 to provide a user interface and/or to perform other graphics-related functions. Graphics controller 176 may include a graphics processor core (for instance, a graphics processing unit (GPU)) and/or component (not shown) to perform graphics-related operations, including and not limited to, decompressing and presenting a motion video, rendering a 2D image of one or more objects of a three-dimensional (3D) model, etc.

Non-volatile storage 162 may store data 130, including executable instructions 132. In the aforementioned exchanges of data 130 between processing device 105 and server 110, processing device 105 may maintain a copy of data 130, for instance, for longer term storage within non-volatile storage 162. Volatile storage 164 may store encrypted data 134 and/or metadata 136. Encrypted data 134 may be made up of at least a portion of data 130 stored within volatile storage 164 in encrypted and/or compressed form according to some embodiments described herein. Executable instructions 132 may make up one or more executable routines such as an operating system (OS), device drivers and/or one or more application routines to be executed by one or more processor cores 170 of processor component 150. Other portions of data 130 may include data values that are employed by one or more processor cores 170 as inputs to performing various tasks that one or more processor cores 170 are caused to perform by execution of executable instructions 132.

As part of performing executable instructions 132, one or more processor cores 170 may retrieve portions of executable instructions 132 and store those portions within volatile storage 164 in a more readily executable form in which addresses are derived, indirect references are resolved and/or links are more fully defined among those portions in the process often referred to as loading. As familiar to those skilled in the art, such loading may occur under the control of a loading routine and/or a page management routine of an OS that may be among executable instructions 132. As portions of data 130 (including portions of executable instructions 132) are so exchanged between non-volatile storage 162 and volatile storage 164, security subsystem 174 may convert those portions of data 130 between what may be their original uncompressed and unencrypted form as stored within non-volatile storage 162, and a form that is at least encrypted and that may be stored within volatile storage 164 as encrypted data 134 accompanied by metadata 136.

Security subsystem 174 may include hardware logic configured or otherwise controlled by security microcode 178 to implement the logic to perform such conversions during normal operation of processing device 105. Security microcode 178 may include indications of connections to be made between logic circuits within the security subsystem 174 to form such logic. Alternatively or additionally, security microcode 178 may include executable instructions that form such logic when so executed. Either security subsystem 174 may execute such instructions of the security microcode 178, or security subsystem 174 may be controlled by at least one processor core 170 that executes such instructions. Security subsystem 174 and/or at least one processor core 170 may be provided with access to security microcode 178 during initialization of the processing device 105, including initialization of the processor component 150. Further, security subsystem 174 may include one or more of the embodiments described herein for unified hardware acceleration of hash functions.

Security credentials 180 may include one or more values employed by security subsystem 174 as inputs to its performance of encryption of data 130 and/or of decryption of encrypted data 134 as part of performing conversions there between during normal operation of processing device 105. More specifically, security credentials 180 may include any of a variety of types of security credentials, including and not limited to public and/or private keys, seeds for generating random numbers, instructions to generate random numbers, certificates, signatures, ciphers, and/or the like. Security subsystem 174 may be provided with access to security credentials 180 during initialization of the processing device 105.

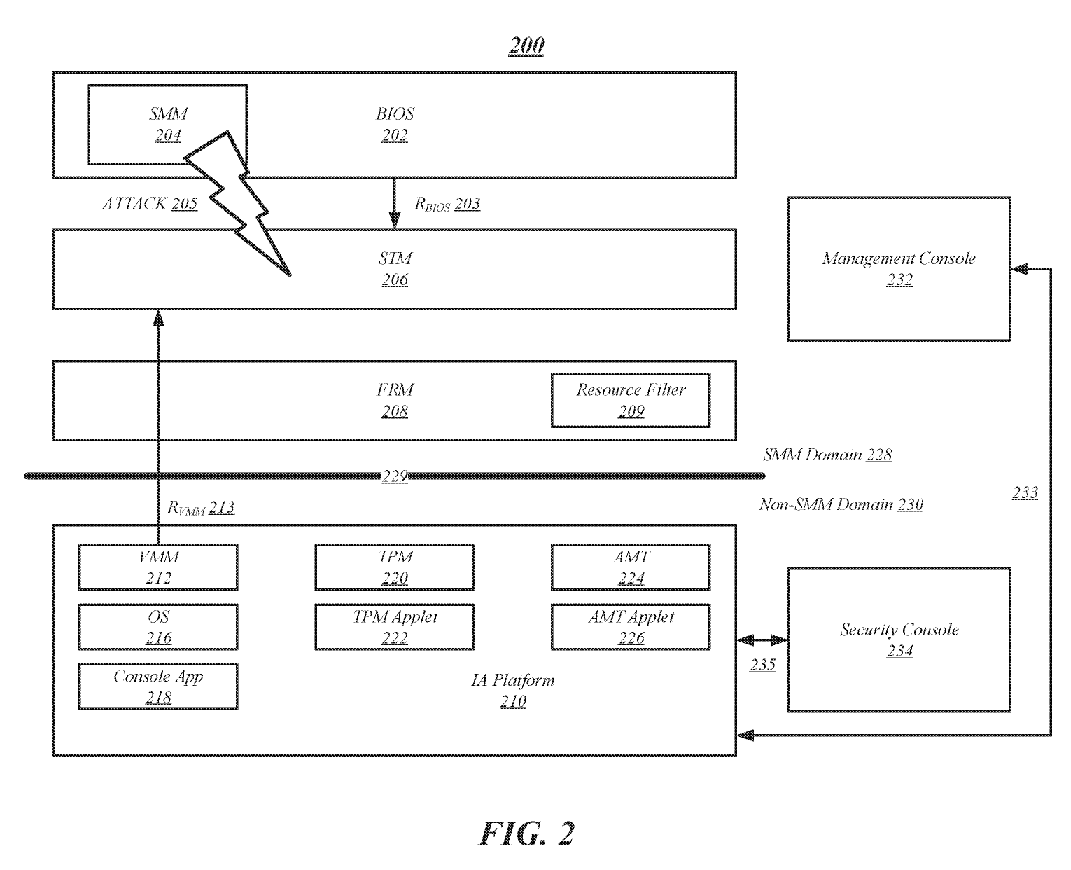

FIG. 2 illustrates an embodiment of a system architecture 200. In some computing systems, a SMI handler known as the SMI Transfer Monitor (STM) 206 may be used to mediate communication regarding platform resource requirements between a BIOS 202, including SMM 204, and security requirements of a measured launch environment (MLE) within platform 210, such as VMM 212. As illustrated, boundary 229 separates architecture 200 into a SMM domain 228 and a non-SMM domain 230. As discussed below, STM 206 may play a role in coordinating system resources between components on opposite sides of boundary 229.

Platform 210 may be one of many computing platforms of various architectures. Platform 210 may include a VMM 212, OS 216, and console application 218 to communicate with management console 232 via communication path 233 and/or security console 234 via communication path 235. In addition, platform 210 may include trusted computing platform module (TPM) 220 and TPM applet 222, discussed further herein. TPM 220 may comprise a dedicated microcontroller designed to secure hardware by integrating cryptographic keys into devices using instructions stored on TPM applet 222. Platform 210 may also include active management technology (AMT) 224 and AMT applet 226, also discussed further herein with respect to various embodiments. AMT 224 and AMT applet 226 may comprise hardware (AMT 224) and firmware (AMT applet 226) for remote out-of-band management to monitor, maintain, update, upgrade, and repair computing systems. In various embodiments, hardware-based management may use a communication channel (through the TCP/IP stack) that is different from software-based communication (which may be through the software stack in the OS).

BIOS 202 may be system firmware to initialize and test system hardware components, and to load a boot loader or an OS 216 from a mass memory device within platform 210. STM 206 may be configured in some embodiments to enforce runtime protections of the MLE when the BIOS 206 SMI handler is running. In some cases, STM 206 may be used only when BIOS 202 loads it into memory and allows it to be initialized by setting a bit for all CPUs. This process of loading and setting the bit to allow STM 206 to be initialized may be called “STM opt-in.”

In some embodiments, the negotiation for resources may favor BIOS 202. SMM 204 may statically declares its resource requirements R_{BIOS} 203 to STM 206, and STM 206 may be required to honor this access requirement list in its entirety. In other words, STM 206 may be configured to never block SMM 204 access to any resource on R_{BIOS} 203 in some embodiments. VMM 212 may deem certain resources R_{VMM} 213 as sensitive or private and request that STM 206 protect these resources and exclude them from SMI handler access. STM 206 may be required to honor these exclusion requests when the resource is not already on the BIOS resource requirement list R_{BIOS} 203. In some embodiments, STM 206 may subsequently block SMM 204 access to these resources. Thus, in some embodiments, STM 206 may refuse an exclusion request from VMM 212 when the resource is also on the BIOS resource requirement list R_{BIOS} 203. VMM 212 may then make a policy decision regarding how to proceed. It may be the case that the platform in question is not compatible with that particular MLE. Once configured, STM 206 may be entered each time an SMI occurs. STM 206 may then invoke SMM 204 code in a virtualized environment such that STM 206 can protect system resources from being observed or modified by the SMM 204 in compliance with a MLE security policy.

At set forth above, an OEM BIOS 202 may pass a list of required resources R_{BIOS} 203 (R) to STM 206 during the booting process. The list may include I/O, MMIO, memory ranges, or other resources. These resources may be needed by the OEM SMM code 204 to function and, thus, STM 206 may be configured to pass through these requirements, i.e., enforce least privilege on the OEM SMM 204. Similarly, the host VMM 212, may pass a list of excluded resources R_{VMM} 213 (E) to STM 206. The list may include I/O, MMIO, memory ranges, or other resources. The resources on the excluded list may be critical resources to guard from the OEM SMM 204. When STM 206 launches, it may be configured to ensure that there is no conflict between R_{BIOS} 203 and R_{VMM} 213 (e.g., an excluded memory range is also present the OEM SMM required list). If a conflict exists, the launch may fail or configured policy based actions may be taken.

There are several ways in which attackers may attempt to compromise a system using SMM vulnerabilities, such as attack 205. SMM 204 may operate in a mode with virtually unmitigated permissions and, thus, may be vulnerable to memory segment replacement attacks, among others. If an attacker is successful in gaining access to SMM 204, the attacker may be given very high, if not the highest, privilege levels within a computing system. Further, in some cases, attackers may reconfigure STM 206 configurations effectively attacking STM 206. For example, STM 206 may be vulnerable due to an outdated VMM that does not include some critical resource in E, or the VMM may be vulnerable such that the original E list is spoofed by malware. Still further, STM 206 may be launched in an early-launch environment called Firmware Resource Monitor (FRM) 208. FRM 208 may be configured launch the VMM/STM and then exit after boot, which means evidence of a compromised STM may not be found via the FRM 208, in some cases. However, techniques described herein may include a persistent resource filter 209, which may be configured to store information with respect to the various resource lists from BIOS 202 and platform 210 during the boot process. In this manner, pre-boot and post-boot resources may be examined (such as using hash functions like SHA-256, for example), and evidence of malicious activity, or other resource problems may be identified.

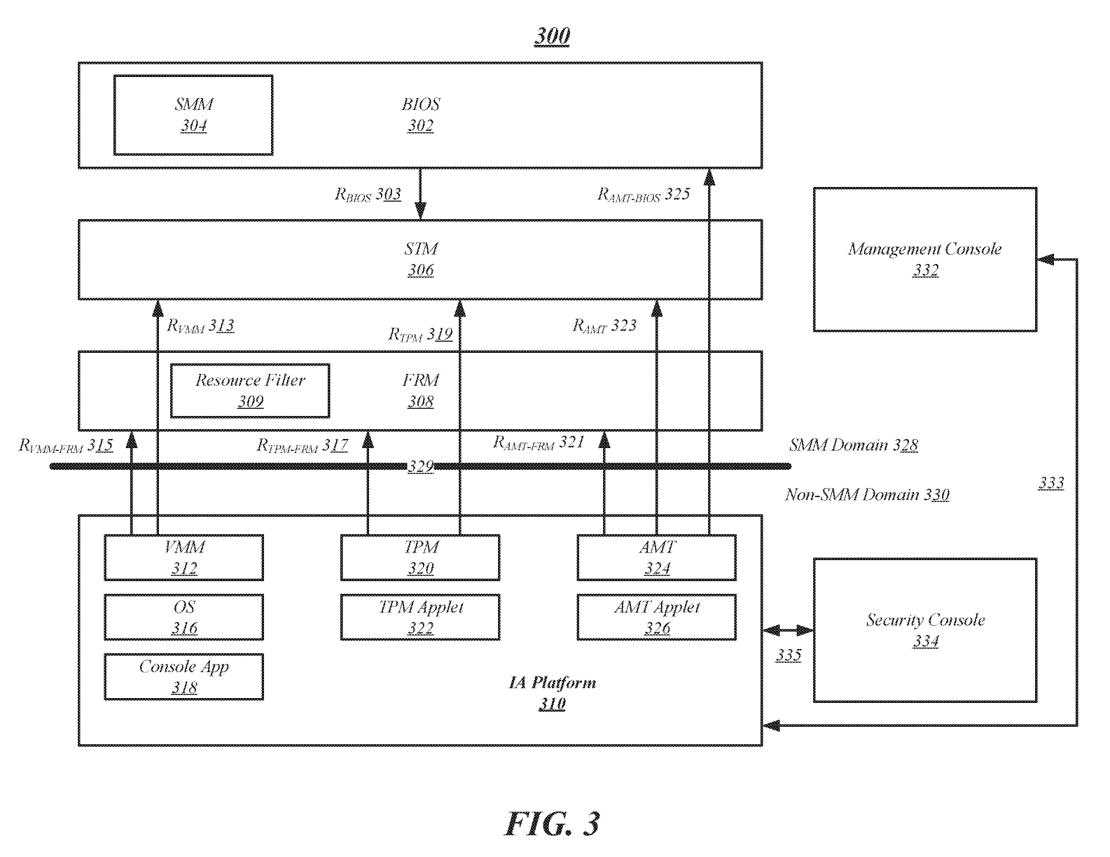

FIG. 3 illustrates an embodiment of a system architecture 300. System architecture 300 includes substantially similar components as system architecture 200, and components have been like-numbered for clarity. However, system architecture 300 illustrates additional communication flows between components used by various embodiments to perform persistent resource monitoring, which will be discussed herein.

Embodiments described herein may address vulnerabilities of STM by providing techniques to identify STM exposure though persistency in FRM 308 using resource filter 309 and through a policy that is configured to recognize a valid STM. Some techniques described herein are achieved by defining the required (R_{BIOS} 303) and excluded (R_{VMM} 313) resource lists, by monitoring actual STM resource list configurations, and detecting changes, if any occur. Determining whether changes have occurred between pre-boot and post-boot resource lists using a persistent resource filter 309 may be performed by comparing hash values (i.e. SHA-1 or SHA-256) in some embodiments, however, simple comparisons, or other types of hash functions may be used. When it has been determined that a resource list is not consistent with expected values, a security alert may be generated by resource filter 309 and communicated to security console 334 via communication path 335, and/or management console 332 via communication path 333.

However, an attacker may also compromise the VMM 312, OS 316, or application 318 that may obtain the resource list configuration information from a security service provider, such as from management console 332 or security console 334, which may comprise external computing systems that communicate with platform 310 via communications paths 333 and 335, respectively. In an example, an attacker may install a rogue set of resource lists that allow the SMM attack to remain hidden. Some techniques described herein addresses this secondary vector of attack by applying machine learning and Byzantine fault tolerance using alternate configuration paths that includes use of AMT 324 and TPM 320 modules. Combined with other techniques described herein, a FRM resource filter 309 policy may be configured. For example, a plurality of modules may each configure a different copy of the resource filter, and when a majority (e.g. two of three) agree that it is safe, the resource filter may be applied. However, if a module disagrees, a possible attack notification may be delivered to security console 334 and/or management console 332.

In addition to R_{BIOS} 303 and R_{VMM} 313, described above with respect to like-numbered elements of FIG. 2, various additional communication flows are illustrated within system architecture 300. The various communication paths may be used to provide management console 332 and/or security console 334 the ability to observe SMM resource activity, set SMM resource behavior, and may provide security alerts when malicious behavior is detected.

In an embodiment, R_{VMM-FRM} 315, R_{TPM-FRM} 317, and R_{AMT-FRM} 321 may be lists of runtime or dynamic excluded resources passed by VMM 312 to resource filter 309 of FRM 308. The communication of these resource lists from VMM 312, TPM 320, and AMT 324, respectively, may configure resource filter 309 to monitor resources identified within the lists. Each list may be stored persistently within a memory of resource filter 309, and used by the techniques described herein to detect malicious activity.

R_{TPM} 319 may include a list of runtime or dynamic excluded resources passed by TPM 320, which may be communicated from a remote administrator from management console 332 and/or security console 334. Likewise, R_{AMT} 323 may include a list of runtime or dynamic excluded resources passed by AMT 324, which may be communicated from a remote administrator from management console 332 and/or security console 334. R_{AMT-BIOS} 325 may include a new set of resources that a remote administrator would like to configure on BIOS 302. In an embodiment R_{AMT-BIOS} 325 may override R_{BIOS} 303, which may be beneficial in various situations, such as when vulnerabilities are discovered and need to be dynamically patched. The use of R_{AMT-BIOS} 325 may be faster to remotely deploy than waiting for an OEM to develop and distribute a similar firmware and/or BIOS upgrade.

In some embodiments, the communication paths described above enable FRM 308, TPM, 320, and AMT 324 to independently verify the integrity of resource lists used by SMM 304. In this manner, remote administrators may be able to observe, and/or be alerted, when anomalies are discovered between pre-boot and post-boot resource lists. Some embodiments may use various combinations of components to provide multiple redundant layers of verification. For example, resource filter 309 may be configured to check various combinations such as STM+FRM, STM+AMT, STM+TPM, STM+AMT+FRM, STM+TPM+FRM, STM+FRM+TPM, and so on. In this manner, an attacker may be required to infiltrate multiple security components to perform an undetected attack. In addition to multiple layers of verification, techniques described herein may employ machine learning and Byzantine logic to identify strong candidates for resource monitoring and expose vulnerabilities, as described in more detail below.

Some of the following figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. For example, a logic flow may be implemented by a processor component executing instructions stored on an article of manufacture, such as a storage medium. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

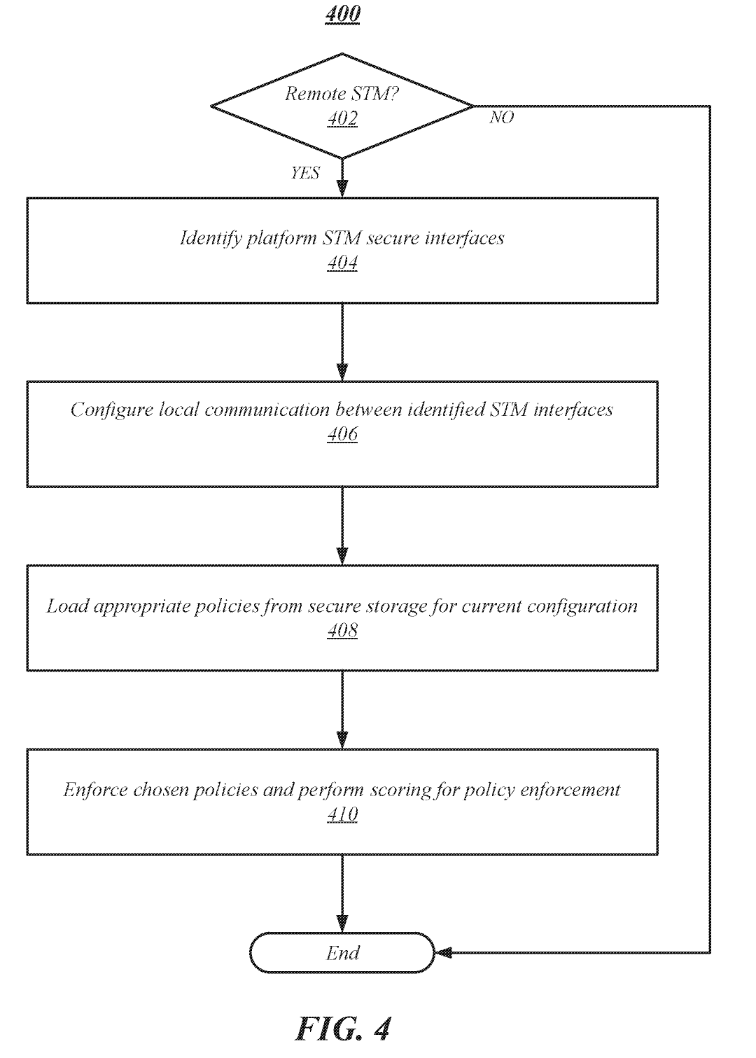

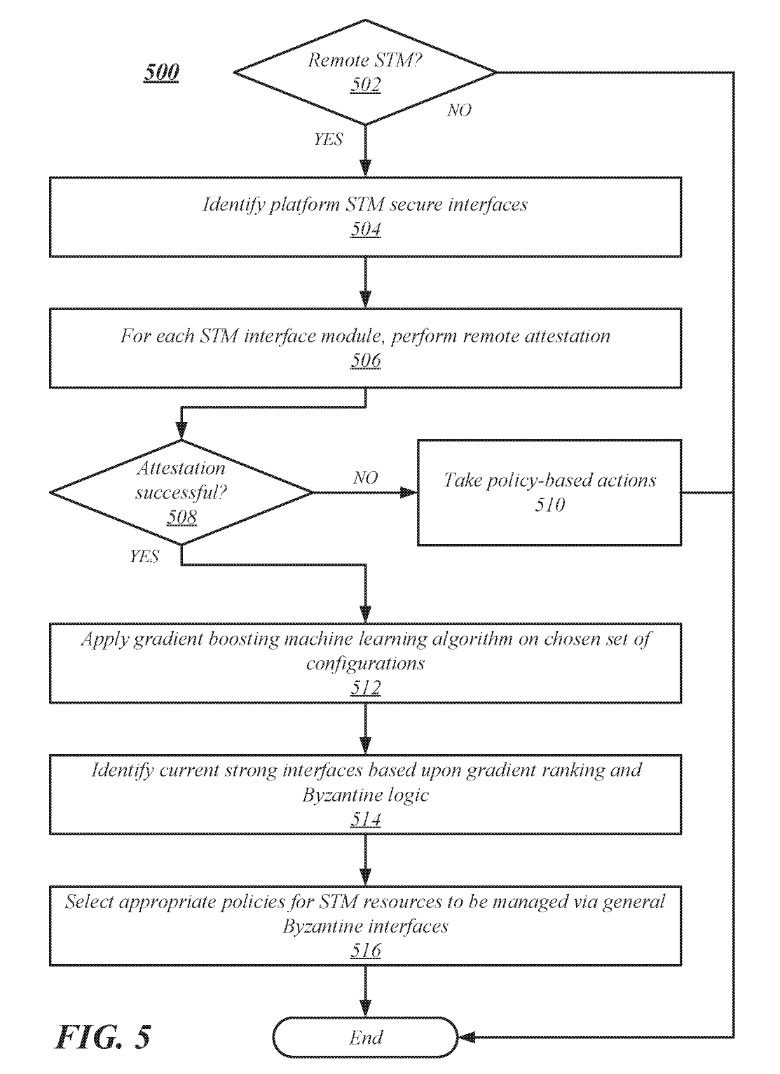

FIG. 4 depicts an illustrative logic flow 400 according to an embodiment. At 402, it may be determined whether there is a remote STM, i.e., whether one or more components within a computer system support STM remote functionality. If not, the logic flow may end. If it is determined that one or more components of a system support remote STM, the logic flow may continue onto 404. At 404, STM secure interfaces may be identified using the techniques described herein. In some embodiments, identified secure interfaces may be identified in FRM, TPM, AMT, and VMM components as described above with respect to FIGS. 2 and 3. At 406, local communications may be configured between identified secure STM interfaces, such as those identified at 404. Local communication may be established in a secure manner, such as using one or more protocols, such as a sigma protocol, for example. At 408, appropriate policies may be loaded from secure storage for the current configuration. For example, certain privilege may be established for certain STM interfaces based upon an assessment of security risk, as described herein. At 410, a chosen policy may be enforced and scoring may be performed for policy enforcement, as set forth below with respect to FIG. 5.

FIG. 5 depicts an illustrative logic flow 500 according to an embodiment. At 502, it may be determined whether there is a remote STM, i.e., whether one or more components within a computer system support STM remote functionality. If not, the logic flow may end. If it is determined that one or more components of a system support remote STM, the logic flow may continue onto 504. At 504, STM secure interfaces may be identified using the techniques described herein. In some embodiments, identified secure interfaces may be identified in FRM, TPM, AMT, and VMM components as described above with respect to FIGS. 2 and 3.

At 506, for each STM interface module, remote attestation may be performed. One or more verification methods, such as using a sigma protocol, may be used to determine that each STM interface is legitimate. If attestation fails for a particular STM interface, privileges may be revoked, set to a minimum level that reduces risk to a system, and an alert may be generated for one or more systems or consoles, such as a security console or management console. Unsuccessful attestation may also result in the end of the logic flow. However, in some cases, the logic flow may continue despite attestation failure, albeit with a different policy being enforced than if attestation was successful. If attestation is successful, the logic flow continues to 512.

At 512, a gradient boosting machine learning algorithm may be applied on chosen set of configurations, such as hardware caps, software versions, known threats, or other parameters. Gradient boosting is a machine learning technique for regression and classification problems, which may produce a prediction model in the form of an ensemble of weak prediction models, typically decision trees. It may build the model in a stage-wise fashion and it may generalizes them by allowing optimization of an arbitrary differentiable loss function. Learning to rank or machine-learned ranking (MLR) is the application of machine learning, which may be supervised, semi-supervised, or reinforcement learning, in the construction of ranking models for information retrieval systems. Training data may consist of lists of items, such as STM interface configurations, with some partial order specified between items in each list. This order is may be induced by giving a numerical or ordinal score or a binary judgment (e.g. “relevant” or “not relevant”) for each item. The ranking model may rank, i.e. produce a permutation of items in new, unseen lists in a way which is similar to rankings in the training data.

At 514, current strong interfaces may be identified based upon gradient ranking above and Byzantine logic. In fault-tolerant computer systems, and in particular distributed computing systems, Byzantine fault tolerance is the characteristic of a system that tolerates the class of failures known as the Byzantine Generals' Problem. Byzantine failures imply no restrictions, which means that a failed node may generate arbitrary data, pretending to be a correct one, which may make fault tolerance difficult. The phrases interactive consistency or source congruency may sometimes be used to refer to Byzantine fault tolerance. The objective of Byzantine fault tolerance is to be able to defend against Byzantine failures, in which components of a system fail with symptoms that prevent some components of the system from reaching agreement among themselves, where such agreement is needed for the correct operation of the system. Correctly functioning components of a Byzantine fault tolerant system may be able to provide the system's service, assuming there are not too many faulty components. Using Byzantine logic, the techniques describes herein may be able to identify security failures, even if a majority of nodes are affected and in agreement.

At 516, appropriate policies may be selected for STM resources to be managed via general Byzantine interfaces. For example, based upon the rankings and analysis described above, policies and privileges may be set among one or more SMT interfaces. If security failure is detected, affected nodes may be shut down, privileges revoked to reach a safe level of security, alerts may be given to one or more management or security consoles, and other steps may be taken to mitigate risk within the system. Likewise, one or more consoles may issue local or remote repairs to one or more affected nodes. If no security problems are found, and nodes are considered ranked highly and safe, privileges may be given for the access of resources and components within the system.

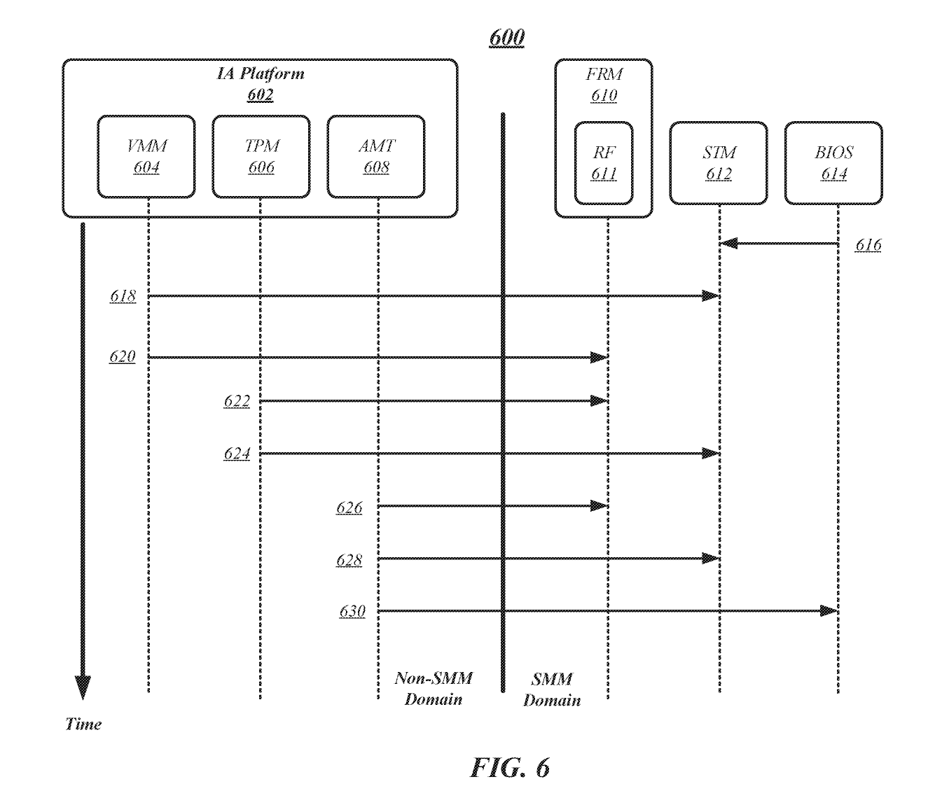

FIG. 6 depicts an illustrative message flow 600 according to an embodiment. Message flow includes a plurality of components for which messages may be sent between. Platform 602 may include VMM 604, TPM 606, and AMT 608, which all may be similar to similar components discussed above with respect to FIGS. 2 and 3. Likewise, FRM 610, resource filter 611, STM 612, and BIOS 614 may represent similar components to those discussed with respect to FIGS. 2 and 3.

At 616, BIOS 614 may statically declare its resource requirements R_{BIOS} to STM 612, and STM 612 may be required to honor this access requirement list in its entirety. In other words, STM 612 may be configured to never block BIOS 604 (or its associated SMM) access to any resource on R_{BIOS} in some embodiments. Likewise, at 618, VMM 604 may deem certain resources R_{VMM} as sensitive or private and request that STM 612 protect these resources and exclude them from SMI handler access. STM 612 may be required to honor these exclusion requests when the resource is not already on the BIOS resource requirement list R_{BIOS}.

At 620, 622, and 626, R_{VMM-FRM}, R_{TPM-FRM}, and R_{AMT-FRM}, respectively, may be sent to FRM 610 and resource filter 611 from each respective source. R_{VMM-FRM}, R_{TPM-FRM}, and R_{AMT-FRM} may be lists of runtime or dynamic excluded resources passed by each component to resource filter 611 of FRM 610. The communication of these resource lists from VMM 604, TPM 606, and AMT 608, respectively, may configure resource filter 611 to monitor resources identified within the lists. Each list may be stored persistently within a memory of resource filter 611, and used by the techniques described herein to detect malicious activity.

At 624, R_{TPM} may be sent from TPM 606 to STM 612 and may include a list of runtime or dynamic excluded resources passed by TPM, which may be communicated from a remote administrator from a management console and/or security console. Likewise, AT 628, R_{AMT} may include a list of runtime or dynamic excluded resources passed by AMT 608, which may be communicated from a remote administrator from management console and/or security console. At 630, in some embodiments, R_{AMT-BIOS} may be communicated from a remote console to AMT 608 and then to BIOS 614, and may include a new set of resources that a remote administrator would like to configure on BIOS 614. In an embodiment RAm_{T-BI}OS may override R_{BIOS}, which may be beneficial in various situations, such as when vulnerabilities are discovered and need to be dynamically patched. The use of R_{AMT-BIOS} may be faster to remotely deploy than waiting for an OEM to develop and distribute a similar firmware and/or BIOS upgrade.

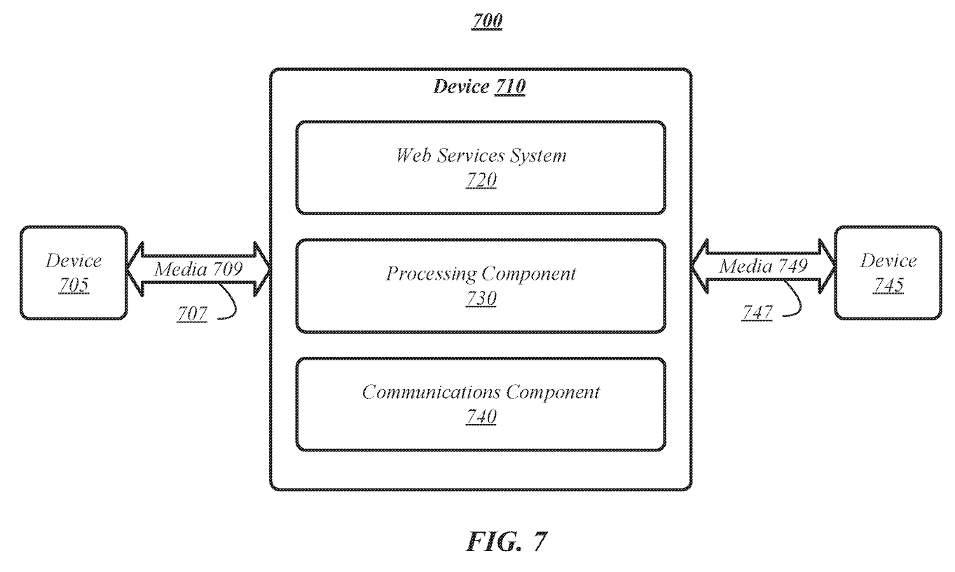

FIG. 7 illustrates a block diagram of a centralized system 700. The centralized system 700 may implement some or all of the structure and/or operations for the web services system 720 in a single computing entity, such as entirely within a single device 710.

The device 710 may comprise any electronic device capable of receiving, processing, and sending information for the web services system 720. Examples of an electronic device may include without limitation a computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 710 may execute processing operations or logic for the web services system 720 using a processing component 730. The processing component 730 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 710 may execute communications operations or logic for the web services system 720 using communications component 740. The communications component 740 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 740 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 709, 749 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 710 may communicate with other devices 705, 745 over a communications media 709, 749, respectively, using communications signals 707, 747, respectively, via the communications component 740. The devices 705, 745, may be internal or external to the device 710 as desired for a given implementation. Examples of devices 705, 745 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 705 may correspond to a client device such as a phone used by a user. Signals 707 sent over media 709 may therefore comprise communication between the phone and the web services system 720 in which the phone transmits a request and receives a web page in response.

Device 745 may correspond to a second user device used by a different user from the first user, described above. In one embodiment, device 745 may submit information to the web services system 720 using signals 747 sent over media 749 to construct an invitation to the first user to join the services offered by web services system 720. For example, if web services system 720 comprises a social networking service, the information sent as signals 747 may include a name and contact information for the first user, the contact information including phone number or other information used later by the web services system 720 to recognize an incoming request from the user. In other embodiments, device 745 may correspond to a device used by a different user that is a friend of the first user on a social networking service, the signals 747 including status information, news, images, or other social-networking information that is eventually transmitted to device 705 for viewing by the first user as part of the social networking functionality of the web services system 720.

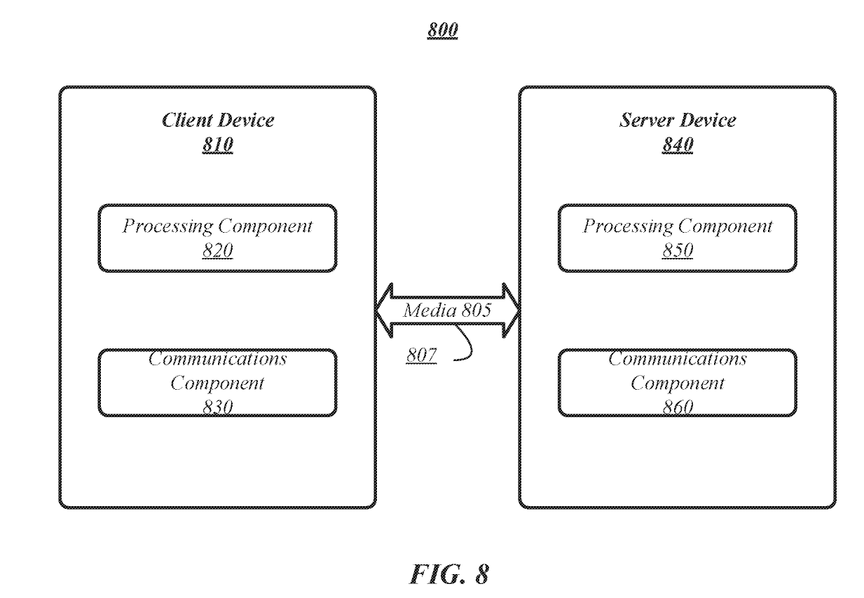

FIG. 8 illustrates a block diagram of a distributed system 800. The distributed system 800 may distribute portions of the structure and/or operations for the disclosed embodiments across multiple computing entities. Examples of distributed system 800 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 800 may comprise a client device 810 and a server device 840. In general, the client device 810 and the server device 840 may be the same or similar to device 710 as described with reference to FIG. 7. For instance, the client device 810 and the server device 840 may each comprise a processing component 820, 850 and a communications component 830, 860 which are the same or similar to the processing component 730 and the communications component 740, respectively, as described with reference to FIG. 7. In another example, the devices 810 and 840 may communicate over a communications media 805 using media 805 via signals 807.

The client device 810 may comprise or employ one or more client programs that operate to perform various methodologies in accordance with the described embodiments. In one embodiment, for example, the client device 810 may implement some steps described with respect client devices described in the preceding figures.

The server device 840 may comprise or employ one or more server programs that operate to perform various methodologies in accordance with the described embodiments. In one embodiment, for example, the server device 840 may implement some steps described with respect to server devices described in the preceding figures.

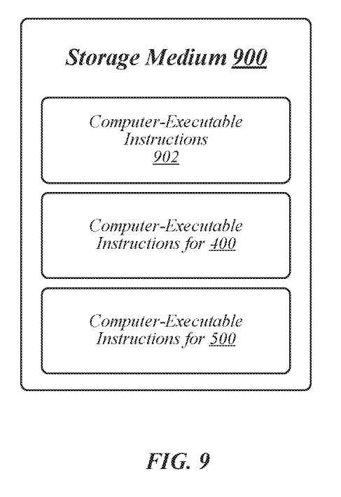

FIG. 9 illustrates an example of a storage medium 900. Storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions 902, which may correspond to any embodiment described herein, or to implement logic flow 400 and/or logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

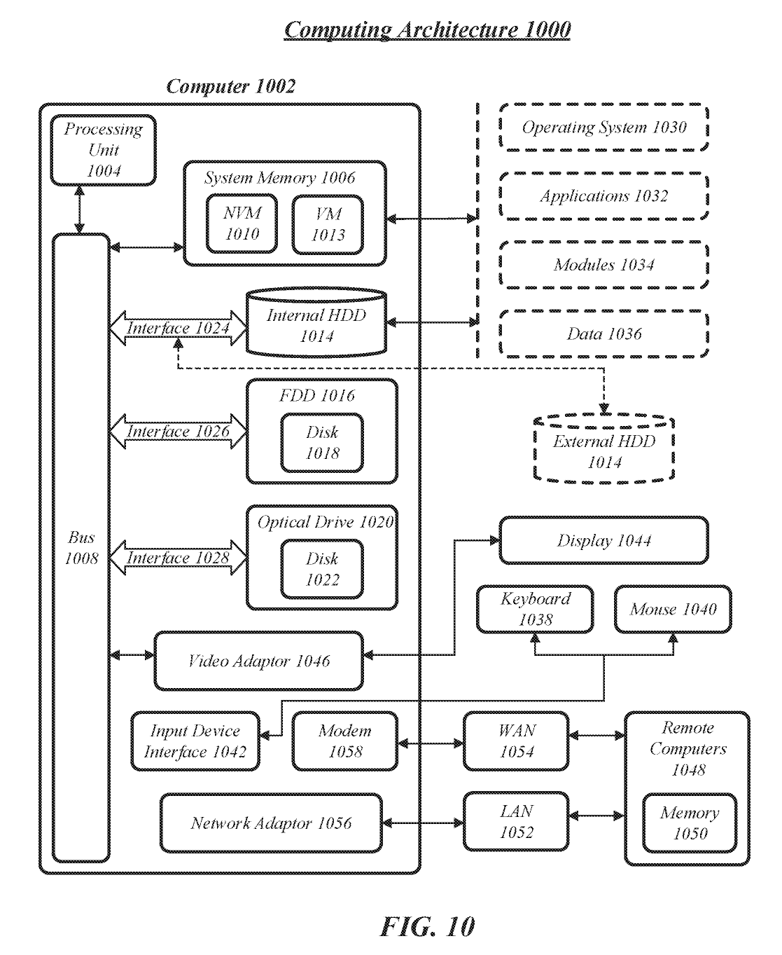

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004. For example, the unified hardware acceleration for hash functions described herein may be performed by processing unit 1004 in some embodiments.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1013. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM, DVD, or Blu-ray). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1013, including an operating system 1030, one or more application programs 1032, other program modules 1034, and program data 1036. In one embodiment, the one or more application programs 1032, other program modules 1034, and program data 1036 can include, for example, the various applications and/or components to implement the disclosed embodiments.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A display 1044 is also connected to the system bus 1008 via an interface, such as a video adaptor 1046. The display 1044 may be internal or external to the computer 1002. In addition to the display 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Examples may include subject matter such as a method, means for performing acts of the method, at least one machine-readable medium including instructions that, when performed by a machine cause the machine to performs acts of the method, or of an apparatus or system for hardware accelerated hash operations according to embodiments and examples described herein.

Example 1 is an apparatus for persistent firmware transfer monitoring in a computer system, comprising: at least one memory; at least one processor; and a resource filter comprising logic, at least a portion of the logic comprised in hardware and executed by the processor, the logic to: receive a list of required resources during a boot operation; receive a list of excluded resources; persistently store the list of required resources and the list of excluded resources after the boot operation has completed; determine that one or more changes occurred to either of the list of required resources and the list of excluded resources during the boot process; and generate a security alert indicating a potential security threat.

Example 2 is the apparatus of Example 1, wherein the determination that one or more changes occurred includes: for each of a plurality of interface modules, determining whether a list of required resources and a list of excluded resources has changed during the boot process.

Example 3 is the apparatus of Example 2, wherein the plurality of interface modules include a trusted computing platform module (TPM), an active management technology module (AMT), and a firmware resource monitor module (FRM).

Example 4 is the apparatus of Example 1, wherein the logic is further configured to: provide the results of the determination to a remote security console to perform a security ranking using gradient boosting machine learning.

Example 5 is the apparatus of Example 1, wherein the logic is further configured to: provide the results of the determination to a remote security console to perform a security ranking using General Byzantine logic.

Example 6 is the apparatus of Example 1, wherein the list of required resourced is received from a system BIOS and the list of excluded resources is received from a VMM.

Example 7 is the apparatus of Example 1, wherein the list of excluded resources is received from a VMM.

Example 8 is the apparatus of Example 1, wherein the resource filter comprises logic to upgrade the list of required resources based upon instructions received from a remote management console.

Example 9 is the apparatus of Example 1, wherein the list of required resources includes one or more of I/O components, MMIO components, one or more memory ranges, and one or more system components.

Example 10 is the apparatus of Example 1, wherein the list of excluded resources includes one or more of I/O components, MMIO components, one or more memory ranges, and one or more system components.

Example 11 is a computer-implemented method for persistent firmware transfer monitoring in a computer system, comprising: receiving, at a resource filter, a list of required resources during a boot operation of the computer system; receiving, at the resource filter, a list of excluded resources; persistently storing, in a memory of the resource filter, the list of required resources and the list of excluded resources after the boot operation has completed; determining that one or more changes occurred to either of the list of required resources and the list of excluded resources during the boot process; and generating a security alert indicating a potential security threat.

Example 12 is the computer-implemented method of Example 11, wherein the determination that one or more changes occurred includes: for each of a plurality of interface modules, determining whether a list of required resources and a list of excluded resources has changed during the boot process.

Example 13 is the computer-implemented method of Example 12, wherein the plurality of interface modules include a trusted computing platform module (TPM), an active management technology module (AMT), and a firmware resource monitor module (FRM).

Example 14 is the computer-implemented method of Example 11, further comprising: providing the results of the determination to a remote security console to perform a security ranking using gradient boosting machine learning.

Example 15 is the computer-implemented method of Example 11, further comprising: providing the results of the determination to a remote security console to perform a security ranking using General Byzantine logic.

Example 16 is the computer-implemented method of Example 11, wherein the list of required resourced is received from a system BIOS.

Example 17 is the computer-implemented method of Example 11, wherein the list of excluded resources is received from a VMM.

Example 18 is the computer-implemented method of Example 11, wherein the resource filter comprises logic to upgrade the list of required resources based upon instructions received from a remote management console.

Example 19 is the computer-implemented method of Example 11, wherein the list of required resources includes one or more of I/O components, MMIO components, one or more memory ranges, and one or more system components.

Example 20 is the computer-implemented method of Example 11, wherein the list of excluded resources includes one or more of I/O components, MMIO components, one or more memory ranges, and one or more system components.

Example 21 is a computer-readable storage medium that stores instructions for execution by processing circuitry of a computing device for persistent firmware transfer monitoring, the instructions to cause the computing device to: receive, at a resource filter, a list of required resources during a boot operation of the computer system; receive, at the resource filter, a list of excluded resources; persistently store, in a memory of the resource filter, the list of required resources and the list of excluded resources after the boot operation has completed; determine that one or more changes occurred to either of the list of required resources and the list of excluded resources during the boot process; and generate a security alert indicating a potential security threat.

Example 22 is the computer-readable storage medium of Example 21, wherein the determination that one or more changes occurred includes: for each of a plurality of interface modules, determining whether a list of required resources and a list of excluded resources has changed during the boot process.

Example 23 is the computer-readable storage medium of Example 22, wherein the plurality of interface modules include a trusted computing platform module (TPM), an active management technology module (AMT), and a firmware resource monitor module (FRM).

Example 24 is the computer-readable storage medium of Example 21, further comprising: providing the results of the determination to a remote security console to perform a security ranking using gradient boosting machine learning.

Example 25 is the computer-readable storage medium of Example 21, further comprising: providing the results of the determination to a remote security console to perform a security ranking using General Byzantine logic.

Example 26 is the computer-readable storage medium of Example 21, wherein the list of required resourced is received from a system BIOS.

Example 27 is the computer-readable storage medium of Example 21, wherein the list of excluded resources is received from a VMM.

Example 28 is the computer-readable storage medium of Example 21, wherein the resource filter comprises logic to upgrade the list of required resources based upon instructions received from a remote management console.

Example 29 is the computer-readable storage medium of Example 21, wherein the list of required resources includes one or more of I/O components, MMIO components, one or more memory ranges, and one or more system components.

Example 30 is the computer-readable storage medium of Example 21, wherein the list of excluded resources includes one or more of I/O components, MMIO components, one or more memory ranges, and one or more system components.

Example 31 is a system for persistent firmware transfer monitoring, comprising: at least one memory module; at least one processor; a management console; and a resource filter module comprising logic, at least a portion of the logic comprised in hardware and executed by the processor, the logic to: receive a list of required resources during a boot operation; receive a list of excluded resources; persistently store the list of required resources and the list of excluded resources after the boot operation has completed; determine that one or more changes occurred to either of the list of required resources and the list of excluded resources during the boot process; generate a security alert indicating a potential security threat; and communicate the security alert to the management console.

Example 32 is the system of Example 31, wherein the determination that one or more changes occurred includes: for each of a plurality of interface modules, determining whether a list of required resources and a list of excluded resources has changed during the boot process.

Example 33 is the system of Example 32, wherein the plurality of interface modules include a trusted computing platform module (TPM), an active management technology module (AMT), and a firmware resource monitor module (FRM).

Example 34 is the system of Example 31, wherein the logic is further configured to: provide the results of the determination to a remote security console to perform a security ranking using gradient boosting machine learning.

Example 35 is the system of Example 31, wherein the logic is further configured to: provide the results of the determination to a remote security console to perform a security ranking using General Byzantine logic

Example 36 is the system of Example 31, wherein the list of required resourced is received from a system BIOS and the list of excluded resources is received from a VMM.

Example 37 is the system of Example 31, wherein the list of excluded resources is received from a VMM.

Example 38 is the system of Example 31, wherein the resource filter comprises logic to upgrade the list of required resources based upon instructions received from the management console.

Example 39 is the system of Example 31, wherein the list of required resources includes one or more of I/O components, MMIO components, one or more memory ranges, and one or more system components.

Example 40 is the system of Example 31, wherein the list of excluded resources includes one or more of I/O components, MMIO components, one or more memory ranges, and one or more system components.

Example 41 is an apparatus for persistent firmware transfer monitoring in a computer system, comprising: at least one memory; at least one processor; means for receiving a list of required resources during a boot operation; means for receiving a list of excluded resources; means for persistently storing the list of required resources and the list of excluded resources after the boot operation has completed; means for determining that one or more changes occurred to either of the list of required resources and the list of excluded resources during the boot process; and means for generating a security alert indicating a potential security threat.

Example 42 is the apparatus of Example 41, wherein the determination that one or more changes occurred includes: for each of a plurality of interface modules, means for determining whether a list of required resources and a list of excluded resources has changed during the boot process.

Example 43 is the apparatus of Example 42, wherein the plurality of interface modules include a trusted computing platform module (TPM), an active management technology module (AMT), and a firmware resource monitor module (FRM).

Example 44 is the apparatus of Example 41, further comprising means for providing the results of the determination to a remote security console to perform a security ranking using gradient boosting machine learning.

Example 45 is the apparatus of Example 41, further comprising means for providing the results of the determination to a remote security console to perform a security ranking using General Byzantine logic

Example 46 is the apparatus of Example 41, wherein the list of required resourced is received from a system BIOS and the list of excluded resources is received from a VMM.

Example 47 is the apparatus of Example 41, wherein the list of excluded resources is received from a VMM.

Example 48 is the apparatus of Example 41, further comprising means for upgrading the list of required resources based upon instructions received from a remote management console.

Example 49 is the apparatus of Example 41, wherein the list of required resources includes one or more of I/O components, MMIO components, one or more memory ranges, and one or more system components.

Example 50 is the apparatus of Example 41, wherein the list of excluded resources includes one or more of I/O components, MMIO components, one or more memory ranges, and one or more system components.

What is claimed is:

1. An apparatus for persistent firmware transfer monitoring in a computer system, comprising:
at least one memory;
at least one processor; and
a resource filter comprising logic, at least a portion of the logic comprised in hardware and executed by the processor, the logic to:
receive a list of required resources during a boot operation;
receive a list of excluded resources;
persistently store the list of required resources and the list of excluded resources after the boot operation has completed;
determine that one or more changes occurred to either of the list of required resources and the list of excluded resources during the boot process; and
generate a security alert indicating a potential security threat.

2. The apparatus of claim 1, wherein the determination that one or more changes occurred includes:
for each of a plurality of interface modules, determining whether a list of required resources and a list of excluded resources has changed during the boot process.

3. The apparatus of claim 2, wherein the plurality of interface modules include a trusted computing platform module (TPM), an active management technology module (AMT), and a firmware resource monitor module (FRM).

4. The apparatus of claim 1, wherein the logic is further configured to:
provide the results of the determination to a remote security console to perform a security ranking using gradient boosting machine learning and General Byzantine logic.

5. The apparatus of claim 1, wherein the list of required resourced is received from a system BIOS and the list of excluded resources is received from a VMM.

6. The apparatus of claim 1, wherein the resource filter comprises logic to upgrade the list of required resources based upon instructions received from a remote management console.

7. The apparatus of claim 1, wherein the list of required resources includes one or more of I/O components, MMIO components, one or more memory ranges, and one or more system components.

8. The apparatus of claim 1, wherein the list of excluded resources includes one or more of I/O components, MMIO components, one or more memory ranges, and one or more system components.

9. A computer-implemented method for persistent firmware transfer monitoring in a computer system, comprising:
receiving, at a resource filter, a list of required resources during a boot operation of the computer system;
receiving, at the resource filter, a list of excluded resources;
persistently storing, in a memory of the resource filter, the list of required resources and the list of excluded resources after the boot operation has completed;
determining that one or more changes occurred to either of the list of required resources and the list of excluded resources during the boot process; and
generating a security alert indicating a potential security threat.

10. The computer-implemented method of claim 9, wherein the determination that one or more changes occurred includes:
for each of a plurality of interface modules, determining whether a list of required resources and a list of excluded resources has changed during the boot process.

11. The computer-implemented method of claim 10, wherein the plurality of interface modules include a trusted computing platform module (TPM), an active management technology module (AMT), and a firmware resource monitor module (FRM).

12. The computer-implemented method of claim 9, further comprising:
providing the results of the determination to a remote security console to perform a security ranking using gradient boosting machine learning and General Byzantine logic.

13. The computer-implemented method of claim 9, wherein the list of required resourced is received from a system BIOS and the list of excluded resources is received from a VMM.

14. The computer-implemented method of claim 9, wherein the resource filter comprises logic to upgrade the list of required resources based upon instructions received from a remote management console.

15. The computer-implemented method of claim 9, wherein the list of required resources includes one or more of I/O components, MMIO components, one or more memory ranges, and one or more system components.

16. The computer-implemented method of claim 9, wherein the list of excluded resources includes one or more of I/O components, MMIO components, one or more memory ranges, and one or more system components.

17. A computer-readable storage medium that stores instructions for execution by processing circuitry of a computing device for persistent firmware transfer monitoring, the instructions to cause the computing device to:
receive, at a resource filter, a list of required resources during a boot operation of the computer system;
receive, at the resource filter, a list of excluded resources;
persistently store, in a memory of the resource filter, the list of required resources and the list of excluded resources after the boot operation has completed;
determine that one or more changes occurred to either of the list of required resources and the list of excluded resources during the boot process; and
generate a security alert indicating a potential security threat.

18. The computer-readable storage medium of claim 17, wherein the determination that one or more changes occurred includes:
for each of a plurality of interface modules, determining whether a list of required resources and a list of excluded resources has changed during the boot process.

19. The computer-readable storage medium of claim 18, wherein the plurality of interface modules include a trusted computing platform module (TPM), an active management technology module (AMT), and a firmware resource monitor module (FRM).

20. The computer-readable storage medium of claim 17, further comprising:
providing the results of the determination to a remote security console to perform a security ranking using gradient boosting machine learning and General Byzantine logic.

21. The computer-readable storage medium of claim 17, wherein the list of required resourced is received from a system BIOS and the list of excluded resources is received from a VMM.

22. The computer-readable storage medium of claim 17, wherein the resource filter comprises logic to upgrade the list of required resources based upon instructions received from a remote management console.

23. The computer-readable storage medium of claim 17, wherein the list of required resources includes one or more of I/O components, MMIO components, one or more memory ranges, and one or more system components.

24. The computer-readable storage medium of claim 17, wherein the list of excluded resources includes one or more of I/O components, MMIO components, one or more memory ranges, and one or more system components.
